(19) United States
(12) Patent Application Publication
(10) Pub. No.: US 2025/0132514 A1
(43) Pub. Date: Apr. 24, 2025

(54) Electrical Plug-In Connector, Vehicle Coupling System, and Electrical Plug-In Connection

(71) Applicant: Rosenberger Hochfrequenztechnik GmbH & Co. KG, Fridolfing (DE)

(72) Inventors: Markus Schichl, Fridolfing (DE); Folke Michelmann, Fridolfing (DE); Simon Huber, Fridolfing (DE)

(21) Appl. No.: 18/682,258

(22) PCT Filed: Aug. 18, 2022
(86) PCT No.: PCT/EP2022/073117

§ 371 Date: Feb. 8, 2024

(30) Foreign Application Priority Data
Aug. 19, 2021 (DE) 10 2021 121 589.7
Sep. 1, 2021 (DE) 10 2021 122 611.2

(51) Int. Cl. H01R 13/05

(52) U.S. Cl. CPC H01R 13/052; H01R 2201/26

(57) ABSTRACT

An electrical plug-in connector (2), having an electrical contact element (4) for electrical and mechanical contacting an electrical mating contact element (5) of an electrical mating plug-in connector (3). The contact element (4) has an operational contact face (6) and a sacrificial contact face (7) arranged on a circumferential surface. The sacrificial contact face (7) and the operational contact face (6) are arranged and designed so that in the course of plugging the plug-in connector (2) together with the mating plug-in connector (3), first the sacrificial contact face (7) contacts the mating contact element (5) and only then the operational contact face (6) contacts the mating contact element (5). The operational contact face (6) is arranged on a front face of the contact element (4) in order to contact the mating contact element (5) frontally.

### CROSS-REFERENCE TO RELATED APPLICATIONS

This US National Stage Non-Provisional Utility Patent Application claims priority to earlier filed PCT Patent Application No. PCT/EP20221073117 which was filed on Aug. 18, 2022; and also claims priority to earlier filed German Patent Application No. 10 2021 122 611.2 which was filed on Sep. 1, 2021; and further claims priority to still earlier filed German Patent Application No. 10 2021 121 589.7 which was filed on Aug. 19, 2021. The entire contents of the identified earlier filed PCT Patent Application and both earlier filed German patent applications is expressly and fully incorporated herein by this reference.

Pursuant to USPTO rules, this priority claim to earlier filed PCT Patent Application No. PCT/EP2022/073117 which was filed on Aug. 18, 2022; and to earlier filed German Patent Application No. 10 2021 122 611.2 which was filed on Sep. 1, 2021, and to still earlier filed German Patent Application No. 10 2021 121 589.7 which was filed on Aug. 19, 2021 is also included in the Application Data Sheet (ADS) filed herewith.

### FIELD OF INVENTION

The invention relates to an electrical plug-in connector, exhibiting an electrical contact element for electrical and mechanical contacting of an electrical mating contact element of an electrical mating plug-in connector, the electrical contact element exhibiting an operational contact face and a sacrificial contact face arranged on a circumferential surface of the electrical contact element.

The invention further relates to a vehicle coupling system for electrical connection of a vehicle to another vehicle or to a stationary device.

The invention still further relates, to an electrical plug-in connection, exhibiting the aforementioned electrical plug-in connector and the electrical mating plug-in connector.

### BACKGROUND OF THE INVENTION

Various electrical plug-in connectors are known from the field of electrical engineering. As is generally known, electrical plug-in connectors serve to transmit electrical supply signals and/or data signals to corresponding mating plug-in connectors. A plug-in connector or mating plug-in connector may be a plug, a circuit-board connector, an installation connector, a socket outlet, a coupling, or an adapter. The term “plug-in connector”, or “mating plug-in connector”, used within the scope of the invention is representative of all variants. The combination of electrical plug-in connector and electrical mating plug-in connector is designated as an electrical plug-in connection.

When plugging in, and when disconnecting, an electrical plug-in connection, a flashover between the contact element and the associated mating contact element may occur under load (that is to say, if the voltage or current is not interrupted beforehand), particularly if an electrical supply voltage is to be transmitted by means of the plug-in connection. This flashover damages the contact face of the participating contact element of the plug-in connector, or of the mating contact element of the mating plug-in connector, in the course of each plugging cycle or disconnecting cycle, and thereby renders the electrical plug-in connection unusable after a certain number of plugging cycles.

With a view to increasing the number of plugging cycles, and therefore the service life of the plug-in connection, it is known to equip the plug-in connector and the mating plug-in connector with, in each instance, a so-called sacrificial contact face, leading in the course of the plug-in procedure, in addition to the actual operational contact face. In the course of the plug-in procedure, the sacrificial contact face of the plug-in connector therefore contacts the sacrificial contact face of the mating plug-in connector before the respective operational contact faces contact one another. Consequently the interfering flashover appears only on the sacrificial contact faces and not on the operational contact faces that are actually relevant for the electrical transmission. Correspondingly, when the plug-in connection is being separated, at first the electrical contact between the operational contact faces is disconnected, and only then the electrical contact of the sacrificial contact faces, likewise limiting a flashover only to the sacrificial contact faces when the plug-in connection is being separated.

A leading contact face may be expedient also for reasons relevant purely to safety (for example, in order firstly to establish an earthing contact or protective-conductor contact between participating electrical assemblies before further electrical contacts are connected). Even in the case of the exclusive transmission of electrical data signals, for instance in high-frequency engineering, leading contact faces may be advantageous, for instance in order to avoid short-term excess voltages or electrostatic discharges in the course of the plug-in procedure (for example, by a ground contact between the participating assemblies firstly being established). For simplification, in the present description and in the claims the term “sacrificial contact face” will be retained also for these applications.

In the case of such “hot-pluggable” or “hot-swappable” plug-in connections, the number of plugging cycles, the service life and the electromagnetic compatibility may be distinctly elevated in comparison with conventional plug-in connections.

In the case of the plug-in connections pertaining to the prior art that are equipped with a sacrificial contact face, sacrificial-contacting and operational-contacting procedures are each undertaken via a radial contact. With a radial contact, however, only a limited contact pressure at the electrical interface can be realized, which equally may not be suitable for all applications. For instance, a low transition resistance, particularly in the course of the transmission of high voltage or high currents, is occasionally essential and is limited by the limited maximum contact pressure. The current-carrying capacity with known radial contacts is also limited by reason of the, as a rule, more filigree structures of spring shackles participating in the radial contact.

In view of the known prior art, an object of the present invention consequently consists in making available an improved electrical plug-in connector with a sacrificial contact face, which is preferentially capable of being subjected to a particularly high contact pressure on an operational contact face.

An object underlying the present invention is also to make available a vehicle coupling system and an electrical plug-in connection with an electrical plug-in connector having a sacrificial contact face, which is preferentially capable of being subjected to a particularly high contact pressure on an operational contact face.

The features described herein, including the claims, relate to advantageous embodiments and variants of the invention.

An electrical plug-in connector is provided, exhibiting an electrical contact element for electrical and mechanical contacting of an electrical mating contact element of an electrical mating plug-in connector.

The plug-in connector may have been connected to an electrical conductor (in particular, to a supply conductor or voltage conductor for electrical supply, but, where appropriate, also to a signal conductor for data transmission) of an electrical assembly, and the mating plug-in connector may have been connected to a corresponding electrical conductor of another electrical assembly. By virtue of the plug-in connection, an electrical data connection and/or supply connection between the two electrical assemblies can consequently be made available. For the purpose of connecting to the respective electrical assembly, the plug-in connector and/or the mating plug-in connector may exhibit, for instance, a respective connecting section facing away from the plug-in region, to which a further plug-in connector connected to the assembly, a cable connected to the assembly, or the electrical conductor of the assembly, can be attached electrically and mechanically.

The electrical plug-in connector and the electrical mating plug-in connector are preferentially respectively a plug-in connector and a mating plug-in connector that can be suitable for transmitting high electric currents. The contact element, or the mating contact element, in particular the respective operational contact face, has preferentially been designed to be suitable for a transmission of high electrical energy—that is to say, for transmitting high electric currents (for example only, and without limitation, 10 A to 700 A) at alternating voltages from 30 V to 1 kV or more or at direct voltages from 60 V to 2 kV or more. But the electrical plug-in connector, or the electrical mating plug-in connector, may also have been designed for electrical signal transmission or for data transmission, for example only, and without limitation in high-frequency engineering.

In accordance with the invention, the contact element exhibits an operational contact face and a sacrificial contact face arranged on a circumferential surface. The sacrificial contact face and the operational contact face have been arranged and designed in such a manner that in the course of plugging the plug-in connector together with the mating plug-in connector at first, the sacrificial contact face, and only then, the operational contact face, contacts the mating contact element.

The “operational contact face” is understood to mean the contact face of the contact element that is provided for the actual contact during operation—that is to say, via which the essential transmission of current or voltage is to be undertaken in the case of a fully closed plug-in connection. The operational contact face may also be designated as the “permanent contact face” or “main contact face”.

By virtue of the “leading” sacrificial contact face in the plug-in direction, a “hot-pluggable” or “hot-swappable” plug-in connector can be made available, with increased number of plugging cycles and increased service life (in particular when the plug-in connector is being used for transmitting electrical supply signals) and with improved electromagnetic compatibility (in particular when the plug-in connector is being used for electrical signal transmission). The plug-in connection can therefore be separated and plugged in without danger or damage even under load—in particular, switching the electric current or the electrical voltage off prior to disconnecting or plugging in the plug-in connection (for instance, by means of appropriate safety circuits) can then be dispensed with.

In accordance with the invention, there is provision that the operational contact face is arranged on a front face of the contact element, in order to contact the mating contact element frontally.

By virtue of the fact that the operational contact face is arranged frontally on the contact element, a distinctly higher contact pressure can be obtained between the contact element and the mating contact element for the actual electrical operational contacting than with a radial contact.

Furthermore, the current-carrying capacity of the electrical plug-in connection may have been optimized by the front contact, because the frontal contact ideally has a contact area, or operational contact area, that corresponds to the cross-sectional area of the contact element in this region. On the other hand, spring shackles in the case of a radial contact occasionally have a distinctly smaller cross-sectional area for the transmission of current, by reason of their elasticity.

By virtue of the proposed electrical plug-in connector, a particularly low transition resistance for a supply connection and/or data connection, as well as a high current-carrying capacity, may be achievable, with, at the same time, long service life and good electromagnetic compatibility of the plug-in connector.

The front face may be a face of the contact element that faces toward the mating contact element in the plug-in direction.

The front face may preferentially have been arranged on a face of the contact element having an area vector that is oriented in the direction of the longitudinal axis of the contact element. The front face may also have been designed to be inclined; for instance, there may be provision that the area vector of the front face is tilted by up to 45° with respect to the longitudinal axis of the contact element, for instance, and without limitation, tilted by up to 30°, 20°, 10°, 5° with respect to the longitudinal axis of the contact element. However, the area vector particularly preferably extends parallel to the longitudinal axis.

The front face has preferentially been designed to be at least substantially plane-parallel or complementary to a corresponding front face of the mating contact element. The front face may also have been formed in structured manner—for instance, it may exhibit a corrugation—and/or may extend in domed manner (as described in the following). For instance, the front face may also be a bottom face of a hollow cylindrical contact element, and/or a front edge of the contact element.

At this point, let attention be drawn to the fact that several operational contact faces may also have been provided which are arranged in distributed manner over the front face, or, where appropriate, over several front faces, of the contact element. For instance, several of the pin contacts described herein may have been provided, or there may be provision that the contact element exhibits several tips or pins, each having an operational contact face.

There is preferentially a conductive electrical connection between the operational contact face and the sacrificial contact face. This electrical connection can preferentially be established by the electrical plug-in connector itself and/or by the electrical assembly connected to the electrical plug-in connector.

In an advantageous development of the invention, there may be provision, in particular, that the contact element forms an electrical connection between the operational contact face and the sacrificial contact face.

In particular, if the contact element forms the electrical connection between the operational contact face and the sacrificial contact face, a low-impedance electrical connection can be made available by simple means. For the purpose of making available the electrical connection between the operational contact face and the sacrificial contact face, the plug-in connector may, for instance, have been formed in one piece. But a multi-piece contact element may also have been provided, the individual components of which have been connected to one another in electrically conductive manner, for instance have been pressed together.

According to a development of the invention, there may be provision that the operational contact face and the sacrificial contact face have been formed from the same material (for instance, and without limitation, from brass).

However, the operational contact face and the sacrificial contact face may also have been formed from different materials, in which case the operational contact face may then have been designed, in particular, for a low-impedance signal transmission, and the sacrificial contact face may have been designed for high resistance to flashovers.

According to a development of the invention, there may be provision that the contact element has been produced by a separating method (“separation”), in particular by a machining method (“machining”). The contact element is preferentially a turned part.

In principle, however, the contact element may also have been produced as a stamped and bent part, or in some other way. Production of the contact element as a turned part, however, can result in a particularly robust contact element.

The contact element has preferentially been formed from as few individual components as possible, which can preferentially be connected to one another by a press fit or by some other connection technique.

In a development of the invention, there may be provision that the operational contact face has been formed on the front face of a contact pin of the contact element.

A pin contact or contact pin is particularly suitable for the operational contacting, particularly in combination with the radial sacrificial contacting.

In a development of the invention, there may be provision that the contact pin is a spring-loaded contact pin. The spring-loaded element of the spring-loaded contact pin preferentially has a suitable spring hardness, in order to generate a spring force that brings about a suitable frontal contact pressure at a given spring deflection. By virtue of the front contact in combination with the spring-loaded contact pin, variable contact forces, in particular, can be made available. Lastly, the plug-in connector may be adjustable with little technical effort as regards the contact force, for instance by exchanging the spring-loaded contact pin or the spring-loaded element thereof. For instance, by this means a plug-in connector can be made available that is adaptable in modular manner as regards the contact force.

As is generally known, by means of spring-loaded contact pins a particularly high contact pressure and also an advantageous compensation of manufacturing tolerances and vibrations can be made possible.

The surface contour of the operational contact face and/or the surface finish of the operational contact face may, in principle, be arbitrary. In an advantageous development of the invention, however, there may be provision, in particular, that the operational contact face has been formed in domed manner (concave or convex).

For instance, the aforementioned contact pin, or spring-loaded contact pin, may exhibit a convex—in particular, conically formed—tip on which the operational contact face has been formed.

The operational contact face of the mating contact element has preferentially been designed to be complementary to the domed operational contact face of the contact element.

For instance, there may be provision that a convex tip of the contact pin, or spring-loaded contact pin, of the contact element has been inserted into a corresponding, concave recess in a front face of the mating contact element that forms the complementary operational contact face. In this way, the contact area available for the electrical transmission can be additionally increased, and in addition a centering between contact element and mating contact element can be obtained, in the manner of a collecting-funnel function.

In a development of the invention, there may be provision that the circumferential surface on which the sacrificial contact face has been formed is an external circumferential surface of the contact element (particularly if the contact element is a pin-shaped contact element).

The sacrificial contact face has preferentially been formed on an external circumferential surface, encircling in the form of a ring at least intermittently (preferentially completely), of a cylindrical section of the contact element.

In an advantageous development of the invention, there may, alternatively or additionally, also be provision that the circumferential surface on which the sacrificial contact face has been formed is an internal circumferential surface of the contact element (particularly if the contact element is a socket-shaped contact element).

The sacrificial contact face may, for instance, have been formed on an internal circumferential surface, encircling in the form of a ring at least intermittently (preferably completely), of a hollow cylindrical section of the contact element.

There may preferentially be provision that the sacrificial contact face of the contact element has been formed on the external circumferential surface of the contact element, and the sacrificial contact face of the mating contact element has been formed on the internal circumferential surface of the mating contact element, or conversely.

In an advantageous development of the invention, there may be provision that the contact element exhibits at least one spring shackle. A spring sleeve has preferentially been provided which exhibits several of the aforementioned spring shackles.

The spring shackles may have been designed to contact electrically and mechanically a cylindrical section of the mating contact element on the external circumferential surface thereof. In principle, however, the spring shackles may also have been designed to contact a hollow cylindrical section of the mating contact element on the internal circumferential surface thereof.

Preferentially, however, the mating contact element exhibits the aforementioned spring shackles (in particular, a socket-shaped mating contact element), in order to contact the sacrificial contact face of the contact element (in particular, of a pin-shaped contact element) on the external circumferential surface thereof.

There may preferentially be provision that the sacrificial contact face is distributed over the internal circumferential surface(s) of the at least one spring shackle.

The sacrificial contact face does not necessarily have to be a completely contiguous surface but may also be composed of several partial surfaces, for instance the individual internal circumferential surfaces of the aforementioned spring shackles. The operational contact face also does not necessarily have to be a completely contiguous surface.

As described herein, the contact element may have been designed, in particular, in the form of a pin and may exhibit an operational contact face arranged on the front face of a contact pin. However, as likewise mentioned herein, the contact element may also have been designed in the form of a socket and may exhibit an operational contact face arranged on a bottom face of a contact socket. These variants, however, are not to be understood as being restrictive.

Where appropriate, there may even be provision (but preferably not) that the contact element exhibits a combination of a contact socket and a contact pin arranged (for instance, coaxially) in the contact socket (as in the case of a coaxial plug-in connector with an inner conductor and an outer conductor). For instance, the contact pin may then have been designed to be spring-loaded and may exhibit the sacrificial contact face, the bottom face of the contact socket forming the operational contact face which has been provided for contacting, for instance, a frontal edge of a corresponding socket-shaped mating contact element.

In an advantageous development of the invention, there may be provision that at least one spring shackle has been mechanically preloaded.

The mechanical preloading of the spring shackles may, in particular, result in an increased contact pressure between the sacrificial contact faces of the contact element and of the mating contact element. Furthermore, the electrical plug-in connector, or the mating plug-in connector, can be more strongly delimited spatially by this means, as a result of which a large number of such plug-in connectors, or mating plug-in connectors, can be arranged in a confined space.

The preloading can, in particular, be made possible by means of a tension band or tension ring (preferentially a metal band or a metal ring) arranged encircling the at least one spring shackle at least in the form of a partial ring.

In a development of the invention, there may be provision that the contact element has been designed to contact the mating contact element with the sacrificial contact face no longer in the fully plugged state of the plug-in connection.

An additional flow of current via the sacrificial contact faces of the contact element and of the mating contact element in the fully plugged state of the plug-in connection can consequently be prevented. In this way, a heating, for instance, of the electrical plug-in connection can substantially be locally limited to the region of the operational contact face. For instance, cases of heating in the region of the outer casing of the contact element or mating contact element—for instance, cases of heating of spring shackles—can then be prevented, which can reduce the emission of heat of the plug-in connector or mating plug-in connector to surrounding components and can thereby increase the possible packing density of electrical plug-in connectors in a (common) insulating housing.

According to a development, there may be provision, in particular, that the contact element exhibits, on the same circumferential surface on which the sacrificial contact face has been arranged, an electrically insulating surface arranged behind the sacrificial contact face in the plug-in direction.

The insulating surface may have been arranged on the outer casing of the contact element, encircling at least in the form of a partial ring, preferentially completely in the form of a ring.

The insulating surface may preferentially directly adjoin the sacrificial contact face in the axial direction.

The insulating surface can be made available, for instance, by a coating of the contact element and/or by a separate component such as, and without limitation, an insulating band or an insulating sleeve.

The electrical plug-in connector and the electrical mating plug-in connector may exhibit mechanical connecting elements, in order to realize a sufficient contact pressure between the contact element and the mating contact element, and/or in order to secure the plug-in connection in its closed state. Corresponding connecting elements may have been designed, for instance, with a view to forming a mutual screw connection, bayonet connection, press connection or latching/snap-action connection.

The invention also relates to an electrical mating plug-in connector, exhibiting an electrical mating contact element for electrical and mechanical contacting of an electrical contact element of an electrical plug-in connector.

The features and advantages that have been described in the foregoing and in the following with respect to the electrical plug-in connector or the contact element thereof can also be carried across to the electrical mating plug-in connector or to the mating contact element, and conversely.

In particular, there may be provision that the mating contact element exhibits an operational contact face and a sacrificial contact face arranged on a circumferential surface, the sacrificial contact face and the operational contact face having been arranged and designed in such a manner that in the course of a procedure for plugging the mating plug-in connector together with the plug-in connector, at first the sacrificial contact face, and only then, the operational contact face contacts the contact element of the plug-in connector, and the operational contact face having been arranged on a front face of the mating contact element, in order to contact the contact element of the plug-in connector frontally.

For instance, there may be provision that the mating contact element forms an electrical connection between the operational contact face and the sacrificial contact face, in particular by the mating contact element having been formed in one piece. The mating contact element may have been produced by a separating method, in particular by a machining method. The mating contact element may, for instance, take the form of a turned part.

There may be provision that in the section provided for contacting with the contact element the mating contact element takes hollow cylindrical form, in order to accommodate the mating contact element within itself at least partially. In this case, the operational contact face may preferentially be an interior front face of the hollow cylindrical mating contact element, for instance a “bottom face” of the hollow cylindrical mating contact element, which may be capable of being contacted by the frontal operational contact face of the contact element.

The operational contact face of the mating contact element may, where appropriate, also exhibit a domed depression, in order to accommodate a domed contact pin.

There may be provision that the circumferential surface on which the sacrificial contact face has been formed is an internal circumferential surface of the mating contact element. The mating contact element may, in particular, exhibit at least one spring shackle, preferentially several spring shackles of a common spring sleeve, the sacrificial contact face being distributed over the internal circumferential surface(s) of the at least one spring shackle. Optionally, the aforementioned spring shackles may also have been mechanically preloaded, for instance by means of a tension band or a tension ring (compare, in particular, also the foregoing description in this respect).

The electrical plug-in connector and/or the electrical mating plug-in connector may, where appropriate (but not necessarily), also exhibit further components in addition to the contact element or the mating contact element, for instance yet further contact elements or mating contact elements (in identical or divergent configuration) of one or more dielectrics, for instance for the purpose of spacing several contact elements or mating contact elements, or a housing of a plug-in connector or a housing of a mating plug-in connector, in particular an electrically insulating housing.

The invention also relates to a vehicle coupling system for electrical connection of a vehicle to another vehicle and/or to a stationary or immovable device. The vehicle coupling system exhibits at least one electrical plug-in connector according to the foregoing and following statements and/or an electrical mating plug-in connector according to the foregoing and following statements.

The term “vehicle” describes any means of locomotion (motorized, but also unmotorized), in particular vehicles on land, on water or in the air, also including spacecraft. A vehicle in the sense of the invention may serve, in particular, for the transportation of persons, goods or tools.

For instance, a vehicle in the sense of the invention may be a rail vehicle, a mobile (in particular, but not necessarily, (partially) autonomous) robotic vehicle such as a robotic lawnmower, a robotic vacuum cleaner or some other service robot, an unmanned aircraft (“drone”) or a means of conveyance for warehouse logistics, such as a (partially) autonomous or remote-controlled industrial truck.

The stationary device to be connected to the vehicle may be, for instance, a stationary base station for the vehicle, such as a charging station (for example, for a robotic lawnmower, a robotic vacuum cleaner, a drone or a mobile means of conveyance from warehouse logistics).

With the proposed vehicle coupling system, rail vehicles in particular can be electrically interconnected.

The vehicle coupling system may, where appropriate, also exhibit mechanical connecting elements, in order to connect the vehicles to one another and/or in order to connect the vehicle to the immovable device. The vehicle coupling system may then have been designed, in particular, to compensate for tractive forces and relative motions between the connected vehicles during driving operation.

Vehicle coupling systems are basically known and can, for instance, connect mechanical, pneumatic and/or electrical components of the vehicles to one another. With regard to the vehicle coupling system according to the invention, it is proposed, in particular, to connect supply lines and/or data lines between the participating vehicles via plug-in connectors and mating plug-in connectors according to the invention.

The proposed vehicle coupling system preferentially exhibits several electrical plug-in connectors and/or mating plug-in connectors, for instance in a row arrangement and/or column arrangement.

The invention also relates to an electrical plug-in connection, exhibiting an electrical plug-in connector according to the foregoing and following statements and the electrical mating plug-in connector (optionally likewise according to the foregoing and following statements).

The proposed electrical plug-in connection may have a particularly long life-cycle with, at the same time, high contact forces and low contact resistance.

Features that have been described/disclosed in connection with one of the subjects of the invention—constituted especially by the electrical plug-in connector, the electrical mating plug-in connector, the vehicle coupling system and the electrical plug-in connection—are also advantageously capable of being implemented for the other subjects of the invention. Similarly, advantages that have been mentioned in connection with one of the subjects of the invention can also be understood in terms of the other subjects of the invention.

In addition, let attention be drawn to the fact that terms such as “including”, “exhibiting” or “with” do not exclude other characteristics or steps. Furthermore, terms such as “a” or “the” that indicate a singular number of steps or features do not exclude a plurality of features or steps, and conversely.

Terms such as “first” or “second” etc. are used primarily for reasons of the distinguishability of respective apparatus features or method features and are not necessarily intended to indicate that features are mutually dependent or have a relationship to one another.

Values and parameters described in this document encompass deviations or fluctuations of ±10% or less, preferentially ±5% or less, more preferably ±1% or less, and quite particularly preferably ±0.1% or less, of the value or parameter designated in the given case, to the extent that these deviations are not excluded in the course of the implementation of the invention in practice. The specification of ranges by means of initial and final values also encompasses all those values and fractions which are included by the range designated in the given case, in particular the initial and final values and a respective mean value.

The invention also relates to an electrical plug-in connector for electrical and mechanical contacting of an electrical mating plug-in connector, the plug-in connector exhibiting a frontal operational contact face and a sacrificial contact face, preferentially a circumferential-surface or radial sacrificial contact face. The further features described in the present description, including the claims, relate to advantageous embodiments and variants of this electrical plug-in connector.

In the following, exemplary embodiments of the invention will be described in more detail with reference to the drawings.

The figures each show preferred embodiment examples in which individual features of the present invention have been represented in combination with one another. Features of an embodiment example are also capable of being implemented separately from the other features of the same embodiment example and can accordingly be readily combined with features of other embodiment examples by a person skilled in the art to yield further expedient combinations and sub-combinations.

### SUMMARY

Our invention generally provides an electrical plug connector for electrical and mechanical contacting a mating electrical contact element of an electrical mating plug-in connector.

A principal aspect of the present invention is an electrical plug-in connector (2), exhibiting an electrical contact element (4) for electrical and mechanical contacting of an electrical mating contact element (5) of an electrical mating plug-in connector (3), wherein the contact element (4) exhibits an operational contact face (6) and a sacrificial contact face (7) arranged on a circumferential surface, and wherein the sacrificial contact face (7) and the operational contact face (6) have been arranged and designed in such a manner that in the course of a procedure for plugging the plug-in connector (2) together with the mating plug-in connector (3) at first the sacrificial contact face (7) and only then the operational contact face (6) contacts the mating contact element (5), characterized in that the operational contact face (6) is arranged on a front face of the contact element (4), in order to contact the mating contact element (5) frontally.

A further aspect of the present invention is an electrical plug-in connector (2) characterized in that the contact element (4) forms an electrical connection between the operational contact face (6) and the sacrificial contact face (7).

A further aspect of the present invention is an electrical plug-in connector (2) characterized in that the operational contact face (6) and the sacrificial contact face (7) have been formed from the same material.

A further aspect of the present invention is an electrical plug-in connector (2) characterized in that the contact element (4) has been produced by a separating method, in particular by a machining method.

A further aspect of the present invention is an electrical plug-in connector (2) characterized in that the operational contact face (6) has been formed on the front face of a contact pin (9) of the contact element (4).

A further aspect of the present invention is an electrical plug-in connector (2) characterized in that the contact pin (9) is a spring-loaded contact pin (9).

A further aspect of the present invention is an electrical plug-in connector (2) characterized in that the operational contact face (6) is domed.

A further aspect of the present invention is an electrical plug-in connector (2) characterized in that the circumferential surface on which the sacrificial contact face (7) has been formed is an external circumferential surface of the contact element (4), preferentially an external circumferential surface, encircling in the form of a ring, of a cylindrical section (10) of the contact element (4).

A further aspect of the present invention is an electrical plug-in connector (2) characterized in that the circumferential surface on which the sacrificial contact face (7) has been formed is an internal circumferential surface of the contact element (4).

A further aspect of the present invention is an electrical plug-in connector (2) characterized in that the contact element (4) exhibits at least one spring shackle, preferentially several spring shackles of a common spring sleeve, the sacrificial contact face (7) being distributed over the internal circumferential surface(s) of the at least one spring shackle.

A further aspect of the present invention is an electrical plug-in connector (2) characterized in that the at least one spring shackle is mechanically preloaded, preferentially by means of a tension band (12) arranged encircling the at least one spring shackle at least in the form of a partial ring.

A further aspect of the present invention is an electrical plug-in connector (2) characterized in that the contact element (4) has been designed to contact the mating contact element (5) with the sacrificial contact face (7) while no longer in the fully plugged state of the plug-in connector (2) together with the mating plug-in connector (3).

A further aspect of the present invention is an electrical plug-in connector (2) characterized in that the contact element (4) exhibits, on the same circumferential surface on which the sacrificial contact face (7) is arranged, an electrically insulating surface (13) arranged behind the sacrificial contact face (7) in the plug-in direction (S).

A still further aspect of the present invention is a vehicle coupling system (15) for electrical connection of a vehicle to another vehicle and/or to a stationary device, exhibiting at least one electrical plug-in connector (2).

An even still further aspect of the present invention is an electrical plug-in connection (1), exhibiting an electrical plug-in connector (2) and the electrical mating plug-in connector (3).

These and other aspects of the present invention are more fully set forth and disclosed herein.

### BRIEF DESCRIPTIONS OF THE FIGURES

In the figures, functionally identical elements have been provided with the same reference symbols.

FIG. 1 shows an electrical plug-in connection according to the invention with an electrical plug-in connector and with an electrical mating plug-In connector in an unplugged state.

FIG. 2 shows the electrical plug-in connection according to FIG. 1 in a partially plugged state.

FIG. 3 shows the electrical plug-in connection according to FIG. 1 in a fully plugged state.

FIG. 4 shows a vehicle coupling system according to the invention with several electrical plug-in connectors in a row-and-column arrangement.

### DETAILED WRITTEN DESCRIPTION OF THE PREFERRED EMBODIMENTS

This disclosure of the invention is submitted in furtherance of the Constitutional purposes of the US Patent Laws “to promote the progress of Science and the useful arts” (Article 1, Section 8).

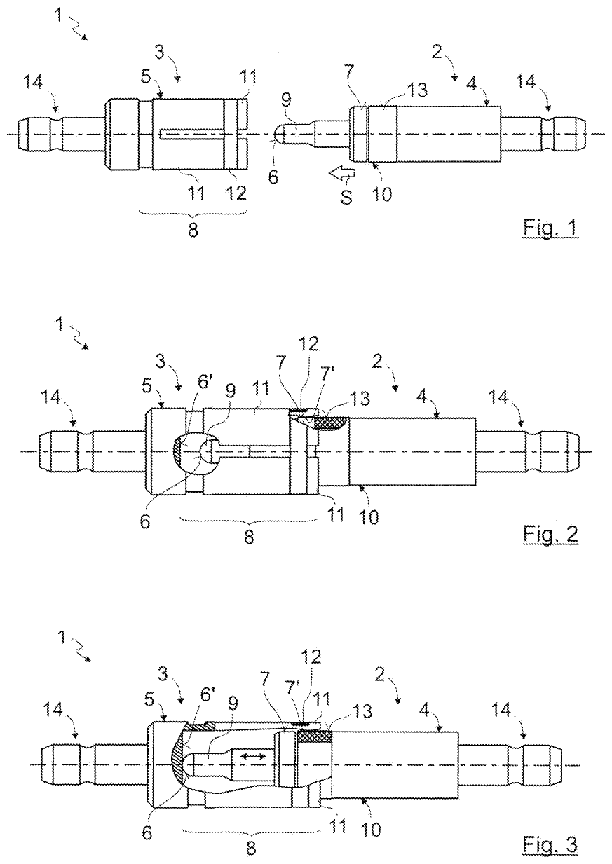

FIGS. 1 to 3 show an electrical plug-in connection 1 according to an exemplary embodiment of the invention in various states of plugging. FIG. 1 shows an unplugged state, FIG. 2 shows a partially plugged state, and FIG. 3 shows a fully plugged state of the plug-in connection 1.

The electrical plug-in connection 1 exhibits an electrical plug-in connector 2 and an electrical mating plug-in connector 3. The electrical plug-in connector 2 exhibits an electrical contact element 4 for electrical and mechanical contacting of an electrical mating contact element 5 of the electrical mating plug-in connector 3.

If a contact element 4 and a mating contact element 5 are plugged in or separated under load, by reason of the difference in electrical potential an equalization of potential with sparking or arcing may occur, which may damage the contact element 4 and the mating contact element 5 or the respective contact face thereof. In accordance with the invention, an expressly defined sacrificial point has been provided, in order to protect the actual point of contact. The contact element 4 consequently exhibits an operational contact face 6 and a sacrificial contact face 7 arranged on a circumferential surface, the sacrificial contact face 7 and the operational contact face 6 having been arranged and designed in such a manner that in the course of plugging the plug-in connector 2 together with the mating plug-in connector 3 at first the sacrificial contact face 7, and only then the operational contact face 6, contacts the mating contact element 5. In the present case, the sacrificial contact face 7 of the contact element 4 contacts a corresponding sacrificial contact face 7′ of the mating contact element 5, as can be clearly discerned in FIG. 2.

Operational contact face 6 is arranged on a front face of the contact element 4, in order to contact a corresponding operational contact face 6′ of the mating contact element 5 frontally. The corresponding operational contact face 6′ of the mating contact element 5 is arranged on an inner front face or on a base of a hollow cylindrical section 8 of the mating contact element 5. A mutual contacting of the two operational contact faces 6, 6′ in the fully plugged state of the plug-in connection 1 is clearly discernible in FIG. 3.

The contact element 4 and the mating contact element 5 each form an electrical connection between the operational contact faces 6, 6′ thereof and the sacrificial contact faces 7, 7′ thereof, as a result of which a flashover can be limited to the sacrificial contact faces 7, 7′ contacting first when the plug-in connector 2 is being plugged into the mating plug-in connector 3. Only upon deeper insertion (see FIG. 3) do the operational contact faces 6, 6′ finally contact each other.

The operational contact face 6, 6′ and the sacrificial contact face 7, 7′ may have been formed from the same material; in particular, the contact element 4 and/or the mating contact element 5 may take the form of turned parts.

In the embodiment example, the operational contact face 6 of the contact element 4 has been formed on the front face of a spring-loaded contact pin 9. By means of the spring-loaded contact pin 9, a particularly high contact pressure and a high vibration resistance of the plug-in connection 1 can be guaranteed. The operational contact face 6 of the contact element 4, or the front face of the spring-loaded contact pin 9, in the embodiment example is domed, which can increase further the available contact area for the operational contacting, particularly in the case of a complementary operational contact face 6′ of the mating contact element 5 (not represented in the figures).

In the embodiment example, the circumferential surface on which the sacrificial contact face 7 of the contact element 4 has been formed is an external circumferential surface, encircling in the form of a ring, of a cylindrical section 10 of the contact element 4. On the other hand, the circumferential surface on which the sacrificial contact face 7′ of the mating contact element 5 has been formed is an internal circumferential surface of the mating contact element 5. In this way, an advantageous radial contact between the sacrificial contact faces 7, 7′ can be made possible. With a view to realizing a high contact pressure and a particularly secure contacting of the sacrificial contact faces 7, 7′, the mating contact element 5 exhibits several spring shackles 11 of a common spring sleeve, the sacrificial contact face 7′ being distributed over the internal circumferential surfaces of the spring shackles 11.

The spring shackles 11 may optionally have been mechanically preloaded, in particular by means of the tension band 12 represented in the figures, encircling the spring shackles 11 in the form of a ring.

At this point, let it be mentioned that features may occasionally be interchangeable between the plug-in connector 2 and the mating plug-in connector 3. For instance, the plug-in connector 2 may also exhibit the spring shackles 11.

There may be provision that the contact element 4 has been designed to contact the mating contact element 5 with the sacrificial contact face 7 no longer in the fully plugged state of the plug-in connection 1 (see FIG. 3). By this means, in the embodiment example there is provision that the contact element 4 exhibits, on the same circumferential surface on which the sacrificial contact face 7 is arranged, an electrically insulating surface 13 arranged behind the sacrificial contact face 7 in the plug-in direction S. In the embodiment example represented, the insulating surface 13 takes the form of an external surface of an insulating sleeve. In this way, the transmission of current during operation can be limited to the operational contact faces 6, 6′.

The plug-in connector 2 and the mating plug-in connector 3 may each be capable of being electrically connected to an electrical assembly which is not represented, for instance via a respective connecting section 14 facing away from the plug-in region. However, a connecting section 14 is not absolutely essential. For instance, there may also be provision that the electrical plug-in connector 2 has been formed in the manner of an adapter and exhibits a bilateral plug-in interface (for instance, a sacrificial contact face 7 on both end sections and also a respective spring-loaded contact pin 9 with a corresponding operational contact face 6), in order to enable a bilateral contacting, or in order to enable a connection between two mating plug-in connectors 3.

In principle, the described electrical plug-in connection 1 can be employed advantageously for arbitrary applications within the entire field of electrical engineering, in particular for transmitting high electrical voltages and/or currents, though also for transmitting electrical data signals. A particularly advantageous use of the electrical plug-in connection 1 may relate to vehicle engineering, in particular to connecting systems for mechanical and electrical connection of a vehicle to another vehicle and/or to a stationary device.

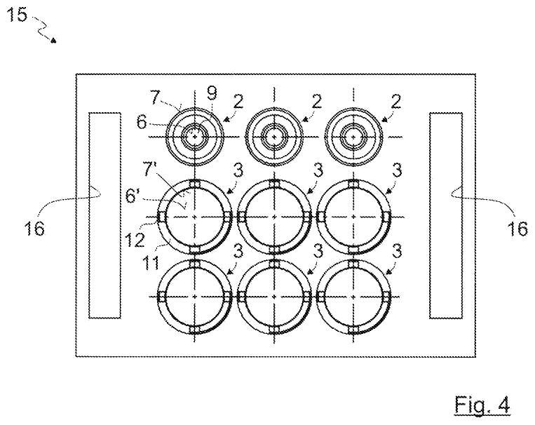

As an example, in FIG. 4 there is a vehicle coupling system 15 according to the invention. The vehicle coupling system 15 exhibits several electrical plug-in connectors 2 according to the foregoing statements and several electrical mating plug-in connectors 3 according to the foregoing statements, which are distributed in a row-and-column arrangement on the interface.

The plug-in connectors 2, or contact elements 4, may, for instance, also have been arranged and interconnected in quasi-coaxial manner. For instance, one of the plug-in connectors 2, or contact elements 4, may have been arranged centrally and can be used for signal transmission (for example, in high-frequency engineering), in which case several further plug-in connectors 2, or contact elements 4, which serve for transmitting a reference voltage (for example, a ground voltage) may have been arranged around the central plug-in connector 2, in particular with the aim of shielding the central plug-in connector 2.

With a view to making available a mechanical connection to another vehicle coupling system of another vehicle or of a stationary device, the vehicle coupling system 15 may, in principle, exhibit known mechanical connecting elements—for instance, the recesses 16 represented—which can be engaged from the rear by corresponding latching elements of another vehicle coupling system.

### Operation

Having described the structure of our electrical plug-in connector, vehicle connection system, and electrical plug-in connection, its operation is briefly described.

An electrical plug-in connector 2 is provided and an electrical mating plug-in connector 3 is provided. A user (not shown) grasps the electrical plug-in connector 2 and axially aligns the electrical plug-in connector 2 with the electrical mating plug-in connector 3 which may, or may not be supported in a housing (not shown). The electrical plug-in connector 2 is axially plugged into the electrical mating plug-in connector 3 so that the electrical plug-in connector 2 and the electrical mating plug-in connector 3 are mechanically and electrically connected to one another.

A principle object of the present invention is an electrical plug-in connector 2 for electrical and mechanical contacting of an electrical mating plug-in connector 3, the electrical plug-in connector 2 comprising: an electrical contact element 4 having an operational contact face 6 at a front face of the electrical contact element 4, in order to contact an electrical mating contact surface 5 of the electrical mating plug-in connector 3 frontally; and a sacrificial contact face 7 on a circumferential surface of the electrical contact element 4; and wherein the sacrificial contact face 7 and the operational contact face 6 of the electrical contact element 4 are arranged and designed so that in a course of plugging the electrical plug-in connector 2 together with the electrical mating plug-in connector 3, first the sacrificial contact face 7 electrically and mechanically contacts the electrical mating contact element 5, and only then the operational contact face 6 of the electrical contact element 4 contacts the electrical mating contact element 5.

A further object of the present invention is an electrical plug-in connector 2 wherein the electrical contact element 4 forms an electrical connection between the operational contact face 6 and the sacrificial contact face 7.

A further object of the present invention is an electrical plug-in connector 2 wherein the operational contact face 6 and the sacrificial contact face 7 are formed of the same material.

A further object of the present invention is an electrical plug-in connector 2 wherein be electrical contact element 4 is produced by a separating method.

A further object of the present invention is an electrical plug-in connector 2 and further comprising: a contact pin 9; and the operational contact face 6 of the electrical contact element 4 is formed on a front face of the contact pin 9.

A further object of the present invention is an electrical plug-in connector 2 wherein the contact pin 9 is spring loaded.

A further object of the present invention is an electrical plug-in connector 2 wherein the operational contact face 6 is domed.

A further object of the present invention is an electrical plug-in connector 2 wherein the circumferential surface on which the sacrificial contact face 7 is formed is an external circumferential surface of the electrical contact element 4.

A further object of the present invention is an electrical plug-in connector 2 wherein the circumferential surface on which the sacrificial contact face 7 is formed is an internal circumferential surface of the electrical contact element 4.

A further object of the present invention is an electrical plug-in connector 2 and further comprising: a spring shackle carried by the electrical contact element 4, and the spring shackle has an internal circumferential surface; and the sacrificial contact face 7 is distributed over the internal circumferential surface of the spring shackle.

A further object of the present invention is an electrical plug-in connector 2 wherein the spring shackle is mechanically preloaded.

A further object of the present invention is an electrical plug-in connector 2 wherein the sacrificial contact face 7 of the electrical contact element 4 contacts the electrical mating contact element 5 only before the electrical contact element 4 is positioned in a fully plugged state in the electrical mating plug-in connector 3.

A further object of the present invention is an electrical plug-in connector 2 wherein the electrical contact element 4 has, on the same circumferential surface on which the sacrificial contact face 7 is arranged, an electrically insulating surface 13 and the electrically insulating surface 13 is positioned behind the sacrificial contact face 7 in the plug-in direction S.

A further object of the present invention is a vehicle coupling system (15) for electrical connection of a vehicle to another vehicle or a vehicle to a stationary device comprising: at least one electrical plug-in connector 2 for electrical and mechanical contacting of an electrical mating plug-in connector 3, the electrical plug-in-connector 2 having an electrical contact element 4 having an operational contact face 6 at a front face of the electrical contact element 4, in order to contact an electrical mating contact element 5 of the electrical mating plug-in connector 3 frontally, and a sacrificial contact face 7 on a circumferential surface of the electrical contact element 4, and wherein the sacrificial contact face 7 and the operational contact face 6 of the electrical contact element 4 are arranged and designed so that in a course of plugging the electrical plug-in connector 2 together with the electrical mating plug-in connector 3, first the sacrificial contact face 7 electrically and mechanically contacts the electrical mating contact element 5, and only then the operational contact face 6 of the electrical contact element 4 contacts the electrical mating contact element 5.

A further object of the present invention is an electrical plug-in connection 1 comprising: an electrical mating plug-in connector 3 having an electrical mating contact element 5; and an electrical plug-in connector 2 for electrical and mechanical contacting the electrical mating plug-in connector 3, the electrical plug-in connector 2 having an electrical contact element 4 having an operational contact face 6 at a front face of the electrical contact element 4, and a sacrificial contact face 7 on a circumferential surface of the electrical contact element 4, and the sacrificial contact face 7 and the operational contact face 6 of the electrical contact element 4 are arranged and designed so that in a course of plugging the electrical plug-in connector 2 together with the electrical mating plug-in connector 3, first the sacrificial contact face 7 electrically and mechanically contacts the electrical mating contact element 5, and only then the operational contact face 6 of the electrical contact element 4 contacts the electrical mating contact element 5, and wherein the operational contact face 6 of the electrical contact element 4 is on the front face of the electrical contact element 4, in order to contact the electrical mating contact element 5 frontally.

A further object of the present invention is an electrical plug-in connector 2 wherein the electrical contact element 4 is produced by a machining method.

A further object of the present invention is an electrical plug-in connector 2 wherein the circumferential surface of the electrical contact element 4 on which the sacrificial contact face 7 is carried has a cylindrical section 10 and the sacrificial contact face 7 encircles the cylindrical section 10 in the form of a ring.

A further object of the present invention is an electrical plug-in connector 2 and further comprising: a common spring sleeve is carried by the electrical contact element 4 and the common spring sleeve exhibits plural spring shackles; and each of the plural spring shackles has an internal circumferential surface; and the sacrificial contact face 7 is distributed over the internal circumferential surfaces of the plural spring shackles.

A still further object of the present invention is an electrical plug-in connector 2 wherein the at least one spring shackle is preloaded by a tension band 12 encircling the at least one spring shackle at least in the form of a partial ring.

An even still further object of the present invention is an electrical plug-in connector 2 wherein the sacrificial contact face 7 of the electrical contact element 4 is spaced apart from the operational contact face 6 of the electrical contact element 4.

In compliance with the statute, the present invention has been described in language more or less specific, as to structural and methodical features. It is to be understood, however, that the invention is not limited to the specific features shown and described since the means herein disclosed comprise preferred forms of putting the invention into effect. The invention is, therefore, claimed in any of its forms or modifications within the proper scope of the appended claims appropriately interpreted in accordance with the Doctrine of Equivalents.

1. An electrical plug-in connector (2) for electrical and mechanical contacting of an electrical mating plug-in connector (3), the electrical plug-in connector (2) comprising:
an electrical contact element (4) having an operational contact face (6) at a front face of the electrical contact element (4), in order to contact an electrical mating contact surface (5) of the electrical mating plug-in connector (3) frontally; and
a sacrificial contact face (7) on a circumferential surface of the electrical contact element (4); and wherein
the sacrificial contact face (7) and the operational contact face (6) of the electrical contact element (4) are arranged and designed so that in a course of plugging the electrical plug-in connector (2) together with the electrical mating plug-in connector (3), first the sacrificial contact face (7) electrically and mechanically contacts the electrical mating contact element (5), and only then the operational contact face (6) of the electrical contact element (4) contacts the electrical mating contact element (5).

2. The electrical plug-in connector (2) as claimed in claim 1 and wherein the electrical contact element (4) forms an electrical connection between the operational contact face (6) and the sacrificial contact face (7).

3. The electrical plug-in connector (2) as claimed in claim 1 and wherein the operational contact face (6) and the sacrificial contact face (7) are formed of the same material.

4. The electrical plug-in connector (2) as claimed in claim 1 and wherein the electrical contact element (4) is produced by a separating method.

5. The electrical plug-in connector (2) as claimed in claim 1 and further comprising:
a contact pin (9); and
the operational contact face (6) of the electrical contact element (4) is formed on a front face of the contact pin (9).

6. The electrical plug-in connector (2) as claimed in claim 5 and wherein the contact pin (9) is spring loaded.

7. The electrical plug-in connector (2) as claimed in claim 1 and wherein the operational contact face (6) is domed.

8. The electrical plug-in connector (2) as claimed in claim 1 and wherein the circumferential surface on which the sacrificial contact face (7) is formed is an external circumferential surface of the electrical contact element.

9. The electrical plug-in connector (2) as claimed in claim 1 and wherein the circumferential surface on which the sacrificial contact face (7) is formed is an internal circumferential surface of the electrical contact element (4).

10. The electrical plug-in connector (2) as claimed in claim 9 and further comprising:
a spring shackle carried by the electrical contact element (4), and the spring shackle has an internal circumferential surface; and
the sacrificial contact face (7) is distributed over the internal circumferential surface of the spring shackle.

11. The electrical plug-in connector (2) as claimed in claim 10 and wherein the spring shackle is mechanically preloaded.

12. The electrical plug-in connector (2) as claimed in claim 1 and wherein the sacrificial contact face (7) of the electrical contact element (4) contacts the electrical mating contact element (5) only before the electrical contact element (4) is positioned in a fully plugged state in the electrical mating plug-in connector (3).

13. The electrical plug-in connector (2) as claimed in claim 12 and wherein the electrical contact element (4) has, on the same circumferential surface on which the sacrificial contact face (7) is arranged, an electrically insulating surface (13) and the electrically insulating surface (13) is positioned behind the sacrificial contact face (7) in the plug-in direction (S).

14. A vehicle coupling system (15) for electrical connection of a vehicle to another vehicle or a vehicle to a stationary device comprising:
at least one electrical plug-in connector, (2) for electrical and mechanical contacting of an electrical mating plug-in connector (3), the electrical plug-in connector (2) having
an electrical contact element (4) having an operational contact face (6) at a front face of the electrical contact element (4), in order to contact an electrical mating contact element (5) of the electrical mating plug-in connector (3) frontally, and
a sacrificial contact face (7) on a circumferential surface of the electrical contact element (4), and wherein
the sacrificial contact face (7) and the operational contact face (6) of the electrical contact element (4) are arranged and designed so that in a course of plugging the electrical plug-in connector (2) together with the electrical mating plug-in connector (3), first the sacrificial contact face (7) electrically and mechanically contacts the electrical mating contact element (5), and only then the operational contact face (6) of the electrical contact element (4) contacts the electrical mating contact element (5).

15. An electrical plug-in connection (1) comprising:
an electrical mating plug-in connector (3) having an electrical mating contact element (5); and
an electrical plug-in connector (2) for electrical and mechanical contacting the electrical mating plug-in connector (3), the electrical plug-in connector (2) having
an electrical contact element (4) having an operational contact face (6) at a front face of the electrical contact element (4), and a sacrificial contact face (7) on a circumferential surface of the electrical contact element (4), and
the sacrificial contact face (7) and the operational contact face (6) of the electrical contact element (4) are arranged and designed so that in a course of plugging the electrical plug-in connector (2) together with the electrical mating plug-in connector (3), first the sacrificial contact face (7) electrically and mechanically contacts the electrical mating contact element (5), and only then the operational contact face (6) of the electrical contact element (4) contacts the electrical mating contact element (5), and wherein
the operational contact face (6) of the electrical contact element (4) is on the front face of the electrical contact element (4), in order to contact the electrical mating contact element (5) frontally.

16. The electrical plug-in connector (2) as claimed in claim 1 and wherein the electrical contact element (4) is produced by a machining method.

17. The electrical plug-in connector (2) as claimed in claim 1 and wherein the circumferential surface of the electrical contact element (4) on which the sacrificial contact face (7) is carried has a cylindrical section (10) and the sacrificial contact face (7) encircles the cylindrical section (10) in the form of a ring.

18. The electrical plug-in connector (2) as claimed in claim 9 and further comprising:
a common spring sleeve is carried by the electrical contact element (4) and the common spring sleeve exhibits plural spring shackles; and
each of the plural spring shackles has an internal circumferential surface; and
the sacrificial contact face (7) is distributed over the internal circumferential surfaces of the plural spring shackles.

19. The electrical plug-in connector (2) as claimed in claim 10 and wherein the at least one spring shackle is preloaded by a tension band (12) encircling the at least one spring shackle at least in the form of a partial ring.

20. The electrical plug-in connector (2) as claimed in claim 1 and wherein the sacrificial contact face (7) of the electrical contact element (4) is spaced apart from the operational contact face (6) of the electrical contact element (4).
